(19) United States
(12) Patent Application Publication
(10) Pub. No.: US 2008/0026771 A1
(43) Pub. Date: Jan. 31, 2008

(54) Mobile terminal position information collection and reporting

(75) Inventor: Ryan Hill, Irvine, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/494,148

(22) Filed: Jul. 26, 2006

(51) Int. Cl. H04Q 7/20

(52) U.S. Cl. 455/456.1

(57) ABSTRACT

Collecting traffic data regarding a plurality of wireless terminals includes periodically receiving Global Positioning System (GPS) location information from each of the plurality of wireless terminals by a location tracking server. For each of the plurality of wireless terminals, the location tracking server accumulates GPS location information. The location tracking server receives information regarding a geographic feature, processes the received GPS location information, and generates a traffic pattern report regarding the geographic feature based upon the accumulated GPS location information.

### BACKGROUND OF THE INVENTION

1. Technical Field of the Invention

This invention relates generally to mobile communications and Global Positioning System (GPS) operations.

2. Description of Related Art

Communication systems technology has advanced greatly over the last 10 years. Mobile communication systems are now ubiquitous and service literally billions of subscribers. Mobile communication systems include cellular communication networks, Wireless Local Area Networks (WLANs), Personal wireless Area Networks (PANs), Worldwide Interoperability for Microwave Access (WiMAX) networks, satellite communication networks, among other wireless communication networks. Currently, handheld devices, automobile-based communication systems, laptop personal computers, desktop personal computers, and a myriad other electronic devices include wireless interfaces. These wireless interfaces support communication with other wireless devices, as well as with communication infrastructures such as the networks described above.

The Global Positioning System (GPS) allows a GPS receiver within a wireless device to locate its position upon the Earth. GPS receivers are typically accurate to within a number of feet of resolution. The cost of GPS receivers continues to decrease such that GPS receivers are now deployed within handheld devices, such as cellular telephones, WLAN telephones, data terminals, and other portable devices.

The Internet enables advertisements to be generated and sent to electronic devices such as personal computers. The Internet facilitates both voice and data point-to-point communications. Storage devices coupled to the Internet are capable of collecting and storing large amounts of data. All of these components together support a large number of applications. While wireless communication networks, the GPS, and the Internet each have their unique advantages, heretofore, the benefits of these disparate systems have not been combined effectively.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a system diagram illustrating a communication system constructed and operating according to one or more embodiments of the present invention;

FIG. 2 is a diagram illustrating location information collection and reporting according to an embodiment of the present invention;

FIG. 3 is diagram illustrating information collection and reporting according to another embodiment of the present invention;

FIG. 4 is a block diagram illustrating a wireless terminal constructed according to an embodiment of the present invention;

FIG. 5 is a block diagram illustrating a server constructed according to one or more embodiments of the present invention;

FIG. 6 is a flow chart illustrating location operation according to an embodiment of the present invention;

FIG. 7 is a flow chart illustrating wireless terminal operations according to one or more embodiments of the present invention; and

FIG. 8 is a flow chart illustrating advertisement generation and delivery according to an embodiment of the present invention.

### DETAILED DESCRIPTION OF THE INVENTION

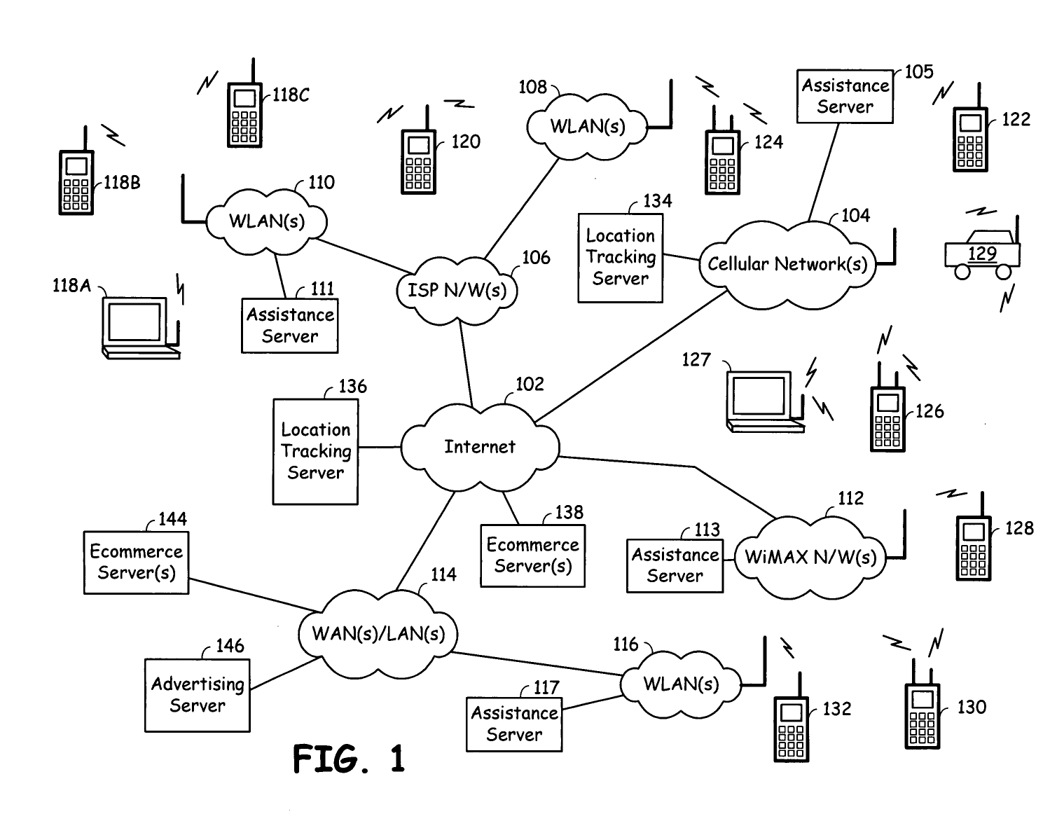

FIG. 1 is a system diagram illustrating a communication system constructed and operating according to one or more embodiments of the present invention. A plurality of interconnected communication networks includes the Internet 102, one or more cellular networks 104, one or more Internet Service Provider (ISP) networks 106, one or more Wireless Local Area Networks (WLAN) 108, 110, and 116, one or more Worldwide Interoperability for Microwave Access (WiMAX) networks 112, and one or more Wide Area Networks/Local Area Networks (WANs/LANs) 114. The communication infrastructure of FIG. 1 supports a number of differing wireless communication interfaces. For example, WLANs 108, 110, and 116 support communications with wireless terminals having WLAN interfaces. For example, WLAN 108 supports WLAN communications with wireless terminal 120 and dual mode wireless terminal 124. Further, WLAN 110 supports WLAN communications with wireless terminals 118A, 118B, 118C, and 120. Further, WLAN 116 supports WLAN communications with wireless terminal 132 and dual mode wireless terminal 132.

Cellular network(s) 104 support cellular communications with wireless terminal 122, dual mode wireless terminal 124, wirelessly-enabled automobile 129, dual mode network-enabled laptop computer 127, and dual-mode wireless terminal 126. Dual-mode terminal 126 supports communications with both the cellular network(s) 104 and the WiMAX network(s) 112. Dual-mode wireless terminal 124 supports wireless communications with cellular network(s) 104 and WLAN 108. As is generally known, a dual-mode terminal may include two or more wireless interfaces, each of which wirelessly interfaces the wireless terminal with a respective wireless communication network or interface standard. The cellular network operates according to one or more cellular protocol interface standards, such as the GSM standard, the WCMA standard, the UMTS standard, one or more CDMA standard, and/or another cellular standard

The WiMAX network 112 supports dual-mode terminal 126, dual-mode laptop computer 127, wireless terminal 128, and dual-mode wireless terminal 130. Dual-mode terminal 130 communicates with both WiMAX network 112 and WLAN 116. Further, wireless terminal 132 supports WLAN communications with WLAN 116.

Each of the wireless terminals illustrated in FIG. 1 includes a GPS receiver. The GPS receiver of each wireless terminal is capable of determining its current location by interacting with three or more servicing GPS satellites. According to the present invention, each wireless terminal of FIG. 1 may from time to time, based upon various criteria, report its location to location tracking server 134 and/or location tracking server 136. As is shown, location tracking server 134 couples to cellular network(s) 104. Location tracking server 134 may be operated by a service provider of the cellular network(s) 104. In such case, location tracking server 134 would be employed to track location of wireless terminals 122, 124, 126, 127, and 129 serviced by the cellular network(s) 104.

Location tracking server 136 couples to Internet 102 via a communication link. Location tracking server 136 sends and receives communications via the Internet 102. For example, location tracking server 136 receives a location updates from any of wireless terminals 118A, 118B, and 118C. Further, location tracking server 136 may communicate with wireless terminals 130 and 132 via WLAN 116 and WAN/LAN 114 to receive location information of wireless terminals 130 and 132. However, location tracking server 134 may also couple via cellular network 104 to Internet 102 to receive location updates from any other of the wireless terminals illustrated in FIG. 1.

Ecommerce servers 138 and 144 service Ecommerce transactions with any of the wireless terminals illustrated in FIG. 1. The Ecommerce server 138 couples to Internet 102, while Ecommerce server 144 couples to WAN/LAN 114. Any of the Ecommerce servers 138 or 144 may also interface with location tracking server 136 or 134 to receive information therefrom.

Advertising server 146 couples to WAN/LAN 114 and is operable to provide advertisements to any of the wireless terminals illustrated in FIG. 1. In its operations, the advertising server 146 may operate in conjunction with location tracking server 136 and 134 to tailor advertisements to any of the wireless terminals based upon their current position information or their position information traffic pattern information as compiled by location tracking server 134 or 136.

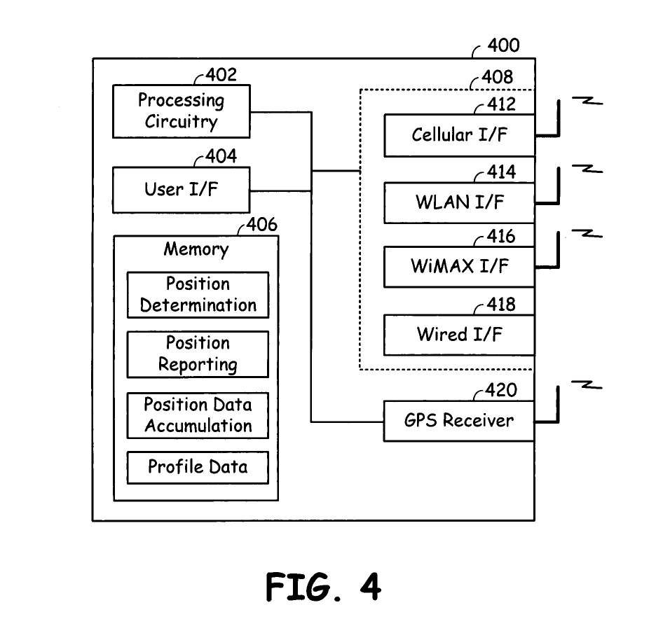

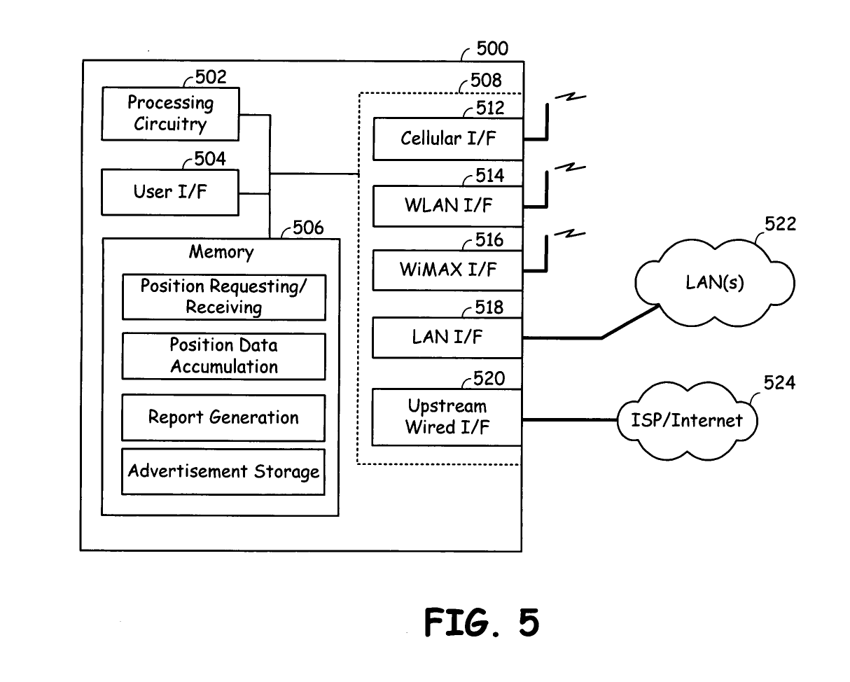

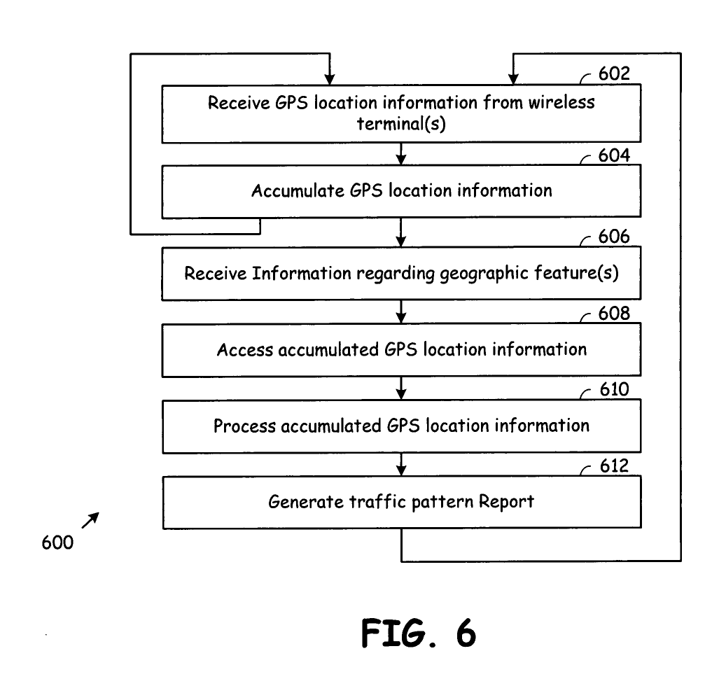

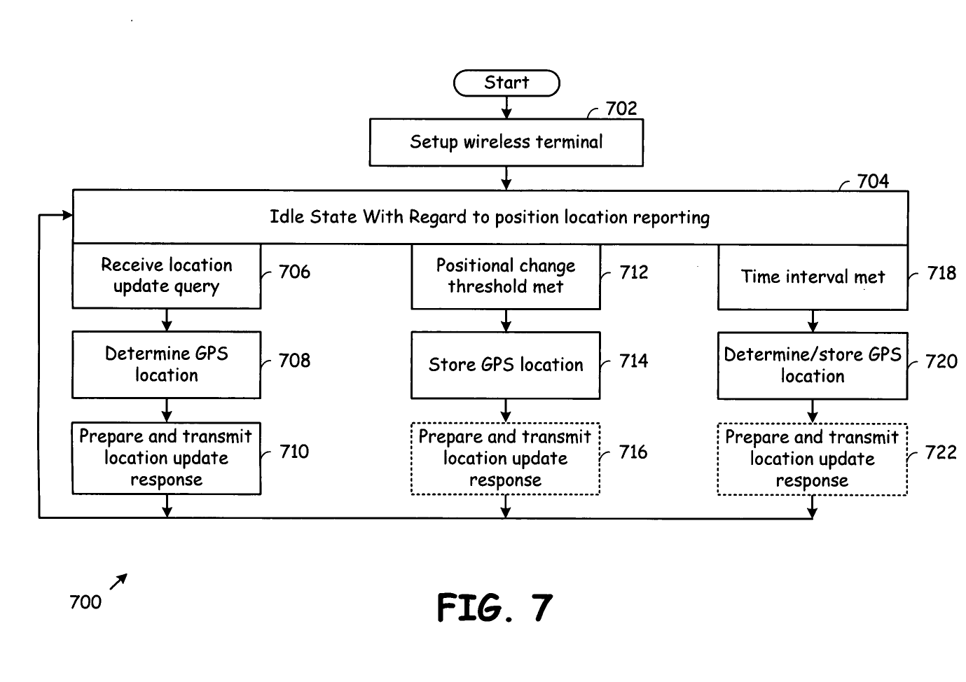

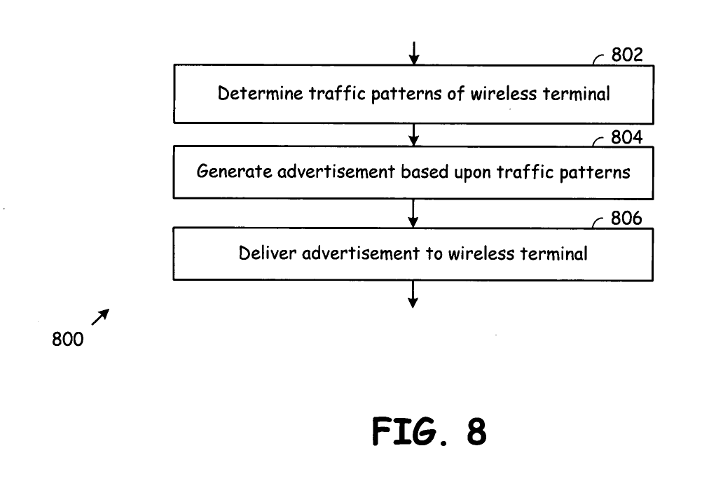

The general structure of wireless terminals will be described with reference to FIG. 4. The general structure of any of the servers 134, 136, 138, 144, or 146 will be described with reference to FIG. 5. Operations of the location tracking servers 134 and 136 will be described further with reference to FIG. 6. The operation of wireless terminals of FIG. 1 with respect to the present invention will be described further with reference to FIG. 7. Finally, one particular operation of advertising server 146 will be described further herein with reference to FIG. 8.

The wireless terminals of FIG. 1 may employ Assisted-GPS (A-GPS) operations in determining their GPS positions. A-GPS is primarily a handset-based technology that uses enhancements to the network to provide additional accuracy and speed of location fix. G PS receivers are connected to the network at various known geographic points to provide additional data to the handset, greatly reducing the time needed to get positioning information and thereby allowing longer battery life. A-GPS variants can provide better in-building location coverage and accuracy as well.

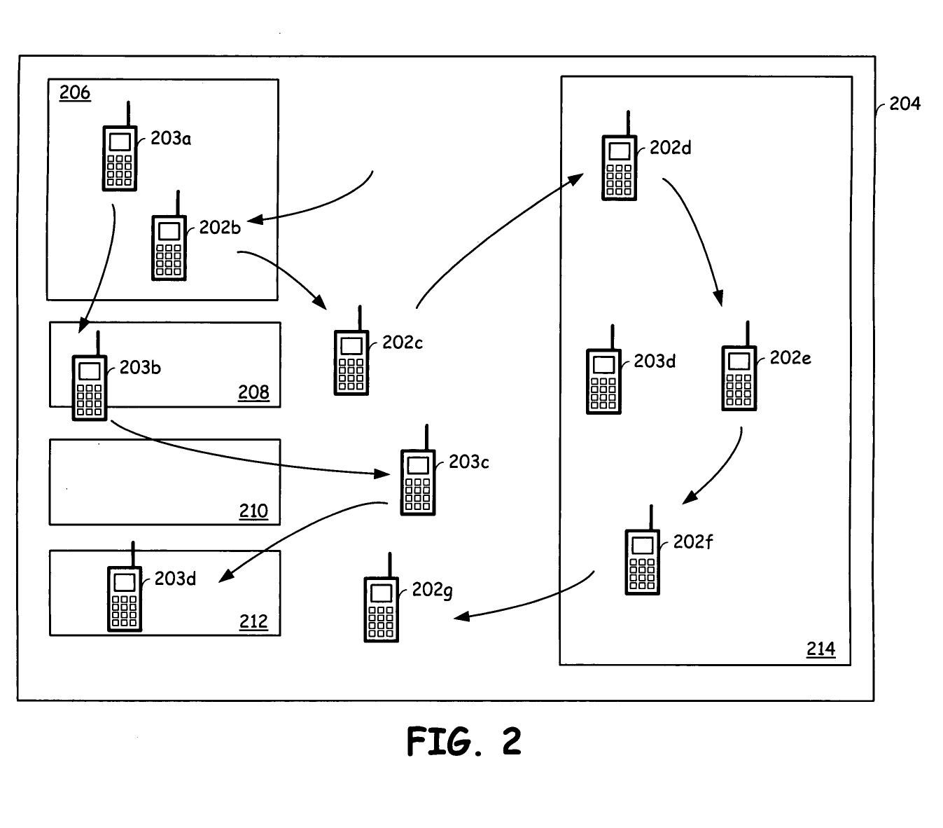

Generally, A-GPS works by providing a GPS reference network in which a series of receivers have a clear view of the sky and can operate continuously. This reference information is then made available to an “assistance server” that may be a dedicated assistance server 105, 111, 113, or 117, or that may be a functional component of a servicing network, such as a base station of the cellular network, an Access point of a WLAN 110, 112, or 116, or a base station of the WiMAX N/W 112, for example. In regular GPS networks there are only GPS satellites and GPS receivers. In A-GPS networks, the receiver, being limited in processing power and normally under less than ideal locations for position fixing, communicates with the assistance server that has high processing power and access to a reference network. Since the A-GPS receiver of the wireless terminal and the Assistance Server share tasks, the GPS location determination process is quicker and more efficient than regular GPS, albeit dependent on cellular or other wireless coverage. The assistance server has the ability to access information from the reference network and has computing power far beyond that of the GPS receiver. With assistance from the network, the GPS receiver of the wireless terminal operates more quickly and efficiently than it would unassisted, because a set of tasks that it would normally handle is shared with the assistance server. The resulting AGPS system boosts performance beyond that of the same receiver in a stand-alone mode. A-GPS operations are particularly relevant to the system of FIG. 2 in which the illustrated wireless handsets are used within a shopping mall.

FIG. 2 is a diagram illustrating location information collection and reporting according to an embodiment of the present invention. The example of FIG. 2 contemplates operation according to the present invention within a shopping mall 204. A wireless terminal 202 carried by a consumer or shopper within the shopping mall is referenced via reference numbers 202a-202g as it moves the mall 204. At a first location 202a, the wireless terminal is within a common area of the mall 204. From position 202a, the wireless terminal moves to position 202b within store 206. Certainly, the owner/operator of store 206 desires to know traffic patterns of potential customers within the mall and within its store. Thus, according to the present invention, a location tracking server 134 tracks the movement of wireless terminal 202 from position 202a to position 202b and to position 202c within the mall. The location tracking server 134 not only tracks the location of a plurality of wireless terminals within the mall 204, but also may later accumulate the position location information and generate reports based upon the position location information. The owner/operator of store 206 may later generate and receive report to indicate the amount of traffic within its store 206 in the mall 204. The owner/operator of store 206 over time may look at the volume of traffic within its store as produced according to the method and system of the present invention to determine whether to change its operations or simply to close the store.

Information may be generated according to the present invention in “real-time”, which may be per capita data. When analyzing the financial performance of a retail location, per capita sales are a major reporting factor. This type of analysis simply considers the point of sale (POS, i.e. register receipts) total divided by the number of people in the store at any given time. Today major retailers do periodic physical counts of the number of people who are in the store using census counts, electronic sensors, or other techniques to determine how many people enter or leave the store. The system and method of the present invention may capture information to provide traffic data directly or indirectly. This traffic information may then be combined with actual real-time POS information recorded at retail locations to indicate per capita sales. A drop or increase in per capita sales could indicate a result of a product mix change. Real-time data in this regard would tell stores whether or not the change was a good change, providing almost immediate feedback.

Other stores 208, 210, 212, and 214, within mall 204 also are relevant to the traffic patterns of potential customers within mall 204. Thus, according to the present invention, the location of wireless terminal 202 is tracked at positions 202c, 202d, 202e, 202f, and 202g. As is shown, at positions 202d, 202e, and 202f, the wireless terminal 202 is within store 214. The duration of time that the wireless terminal 202 remains within store 214 is relevant to the owner/operator of store 214. Thus, a report generated according to the present may include information relating to the duration of time that wireless terminal remains within store 214.

The traffic patterns of the wireless terminal 202 within mall 204 are relevant to a user profile corresponding to wireless terminal 202. Thus, use profile data may be captured and collected for wireless terminal 202 for later use in generating advertisements within the mall. For example, according to the present invention, an advertising server 146 may be provided with information relating to wireless terminal 202 at position 202d, 202e, and 202f, within store 214. The advertising server 146 of FIG. 1 may provide target advertising to the user of wireless terminal 202 while at positions 202d, 202e, and 202f, within the mall. Alternately, when the wireless terminal 202 moves to position 202g, an additional advertisement may be sent to the wireless terminal 202 from advertising server 146 to entice the user of wireless terminal 202 to return to the store 214 to complete a transaction.

In another operation according to the present invention, stores 206 and 208 are both shoe stores, and a customer has entered both stores using his/her wireless terminal A location tracking server recognizes that the user of the wireless terminal 203 has visited both shoe store 206 (position 203a) and shoe store 208 (position 203b) and knows that store 212 also sells shoes. The location tracking server and the advertising server operate in cooperation to send an advertisement to terminal 203 (at position 203c) to notify the user of wireless terminal 203 that store 212 is also a shoe store and that the use should enter store 212 in an attempt to buy shoes at store 212 (at position 203d). In one operation, the advertising server sends an electronic discount coupon to the wireless terminal 203 (position 203c) to entice the user to enter store 212. Additionally, in another operation, if the tracking server determines that the user of wireless terminal 203 is moving away from store 212, it send another advertisement to the wireless terminal 203 offering a greater discount.

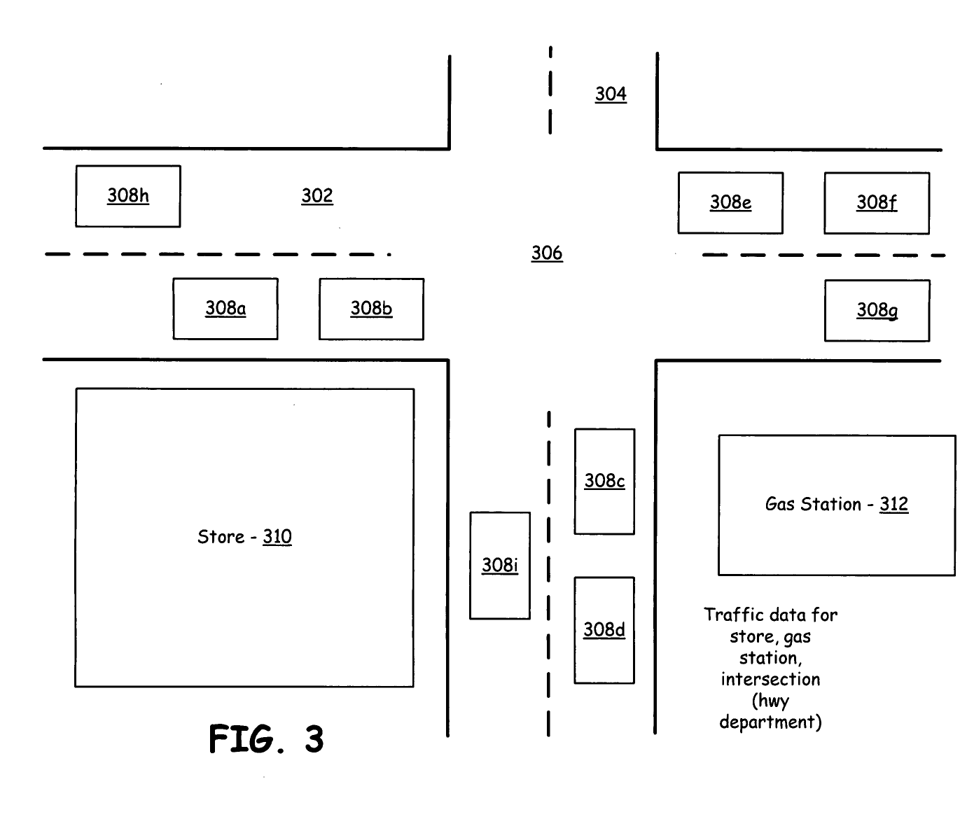

FIG. 3 is diagram illustrating information collection and reporting according to another embodiment of the present invention. Illustrated in FIG. 3 are the intersection of roads 302 and 304 at intersection 306. Residing at a first corner of intersection 306 is a store 310. Residing at a second corner of intersection 306 is gas station 312. Wireless terminals/cars/devices 308a through 308i are illustrated simply as automobiles in FIG. 3. These wireless devices 308a through 308i may be permanently coupled to the corresponding automobiles. Alternately, these wireless devices 308a through 308i may be wireless handsets within the automobiles. Over a period of time, an amount of traffic passes through intersection 306 traveling on roads 302 and 304. The owner/operator of store 310 and gas station 312 desire to understand the movement of potential consumer traffic through intersection 306. Thus, according to the present invention, wireless terminals 308a-308i, in conjunction with location tracking server 134/136, collect information regarding the movement of the wireless terminals 308a through 308i through the intersection 306. This information may be employed to create traffic pattern reports for the owner/operator of store 310 and the owner/operator of gas station 312 for use in their marketing, advertising, and/or pricing. Further, according to the present invention, an advertising server 132 and/or 134 in conjunction with location tracking server may determine that particular advertisement should be presented and delivered to one or more of the wireless terminals 308a through 308i as they approach intersection 306. Such advertisements may entice the users of wireless terminals 308a through 308i to enter store 310 or gas station 312 to complete a transaction therein.

FIG. 4 is a block diagram illustrating a wireless terminal constructed according to an embodiment of the present invention. The wireless terminal 400 includes processing circuitry 402, user interface 404, memory 406, communication interface 408, and GPS receiver 420. The processing circuitry 402 may be a microprocessor, a digital signal processor, an application-specific integrated circuit, specialized circuitry, or another type of circuitry that is capable of executing software instructions and/or processing data. The user interface 404 may include a keypad, a display, a voice interface, or another type of interface that allows a user of wireless terminal 400 to interface with wireless terminal 400. The memory 406 may be random access memory, read only memory, optical memory, hard disk drive memory, or another type of memory that is capable of storing instructions and data. The communication interface 408 includes one or more of a cellular interface 412, a WLAN interface 414, a WiMAX interface 416, and a wired interface 418. The cellular interface 412 interfaces the wireless terminal 400 to one or more cellular networks and supports one or more communication protocol interface standards, such as the GSM standard, the WCMA standard, the UMTS standard, one or more CDMA standard, and/or another cellular standard. The WLAN interface 414 may support any of the IEEE 802.11 standards or another WLAN interface standard(s). The wired interface 418 may include a cable interface, an optical interface, or another wired interface. The GPS receiver 420 interfaces with GPS system satellites to receive signals from the satellites to determine a position of the wireless terminal 400 based upon such interaction.

According to the present invention, the memory 406 stores software instructions and data that enable the wireless terminal 400 to support position determination, position reporting, and other operations relating to the collection and reporting of GPS position information of the wireless terminal 400. Thus, memory 406 stores position determination functionality instructions, position reporting instructions, position data accumulation instructions, and profile data. The functions executed by wireless terminal 400 upon execution of the software stored in memory 406 causes the wireless terminal 400 to operate according to the present invention. These operations will be described further with reference to FIGS. 6 through 8.

FIG. 5 is a block diagram illustrating a server constructed according to one or more embodiments of the present invention. The server 500 may be a location tracking server 134 or 136, an ecommerce server 138 or 144, or an advertising server 146. The server 500 includes processing circuitry 502, a user interface 504, memory 506, and a communication interface 508. As was the case with the wireless terminal 400, the processing circuitry 502 and the memory 506 may be various types of processors, circuitry, and/or storage devices. Further, the user interface 504 allows the user to interface with server 500. The communication interface 508 includes a cellular interface 512, a WLAN interface 514, a WiMAX interface 516, a LAN interface 518, and an upstream wired interface 520. The cellular interface 512 supports wireless communications between the server 500 and a cellular network. The WLAN interface 514 supports communication between the server 500 and one or more WLANs. The WiMAX interface 516 supports communications between the server 500 and a WiMAX network. The LAN interface 518 supports communications between the server 500 and a one or more LANs 522. Finally, the upstream wired interface 520 supports communications between the server 500 and an ISP network and/or the Internet 524.

The functionality of the server 500 may be embodied by software instructions stored in memory 506 that are executed by processing circuitry 502. Such functionality includes position requesting/receiving software, position data accumulation software, report generation software, and advertisement storage software. Upon execution of these various software instructions stored in memory 506 by processing circuitry 502, the server 500 executes operations of the present invention and will be described further with reference to FIGS. 6 through 8.

FIG. 6 is a flow chart illustrating location operation according to an embodiment of the present invention. Operation 600 commences with the location tracking server receiving GPS location information from one or more wireless terminals (step 602). The receipt of GPS location information from the wireless terminals will typically be on a periodic basis, but could be in response to position location requests sent to particular wireless terminals. Operation continues with the location tracking server accumulating the GPS location information received from the one or more wireless terminals (step 604). The accumulation operations will continue and the location tracking server will continue to receive GPS location information from the wireless terminals at step 602 indefinitely.

However, from time to time, the location tracking server will be called upon to generate reports for use by subscribers or users of the system. In such case, the location tracking server would receive information regarding geographic features for which a report would be required (step 606). The geographic feature may be, for example, the geographic boundaries of a store, the geographic boundaries of an intersection and surrounding area, a particular location on a road for which traffic information is identified, or another particular geographic location or geographic area.

Based upon the information regarding the geographic features received by the location tracking server at step 606, the location tracking server accesses accumulated GPS location information pertinent to the geographic features (step 608). Then, the location tracking server processes the accumulated GPS location information to produce a desired result (step 610). The desired result may be to identify wireless terminals that were within or near the geographic feature at particular points of time. The relevant information desired may also include a duration of time at which each wireless terminal is proximate or within the geographic features. Further, the information may include the average duration time for which a wireless terminal is near or within the geographic feature. Finally, the location tracking server generates a traffic pattern report based upon the processing that was performed at step 610 (step 612). This traffic pattern report may be delivered electronically or in a written format to a requesting party. From step 612 operation returns to step 602.

FIG. 7 is a flow chart illustrating wireless terminal operations according to one or more embodiments of the present invention. Operation 700 commences with setting up a wireless terminal (step 702). In setting up the wireless terminal, a location tracking server first validates its interaction with the wireless terminal. For example, in a cellular network, part of a subscription agreement of the wireless terminal is that the cellular network or another servicing device would be able to track location of the wireless terminal over time. Further, a subscriber using the wireless terminal may be given a reduction in subscription rate or preferred ecommerce transactions with third parties in exchange for allowing the cellular network or other wireless network to track the location of the wireless terminal over time.

Once the setup of the wireless terminals is complete at 702, the wireless terminal resides in an idle state with regard to its position location reporting activities (step 704). Three differing mechanisms in reporting position location information by the wireless terminal are illustrated in FIG. 7. However, various other mechanisms according to the present invention may be employed for determining at what time the mobile terminal should not only determine the GPS location, but report the GPS location as well. Further, the wireless terminal may simply record its position from time to time and then report all of its position information along with the times at which the position information was recorded in a general report.

In a first operation of the general operation 700 of FIG. 7, the location tracking server sends a location update query to a target wireless terminal based upon a triggering event. In response thereto, the target wireless terminal receives the location update query (step 706). In response to the location update query 706, the target wireless terminal determines its GPS location (step 708). Then, the target wireless terminal prepares and transmits a location update response to the location tracking server that includes GPS location information determined at step 708 (step 710). From step 710, operation returns to the idle state at step 704. At step 710, the wireless terminal may provide additional GPS location information and corresponding time information that was previously collected and locally stored.

Another operation that results in the wireless terminal determining its location occurs when a positional change threshold is met (step 712). The wireless terminal may continually monitor its GPS location over time. Then, based upon its continually-monitored GPS location, the wireless terminal may determine that it has moved a threshold distance. When this positional change threshold is met at step 712, the wireless terminal stores its GPS location (step 714). The wireless terminal may simply store its GPS location over time with corresponding time stamps. Then, eventually, the wireless terminal will prepare and transmit a location update response to the location tracking server that includes one or more GPS location position indications (step 716). From step 716, operation returns to step 704.

According to another operation, the wireless terminal determines its GPS location when a particular time interval is met (step 718). For example, the wireless terminal may report its location every minute, every few minutes, every few seconds, or according to another time interval. When this time interval is met at step 718, the wireless terminal determines its GPS location and stores its GPS location in memory (step 720). Then, at this time, or at some other interval of time, the wireless terminal prepares and transmits a location update response to the location tracking server (step 722). This location update response may include a single GPS location information or may include a plurality of GPS location information. At step 722, operation returns to step 704.

FIG. 8 is a flow chart illustrating advertisement generation and delivery according to an embodiment of the present invention. Operation 800 includes determining the traffic patterns of a wireless terminal (step 802). The traffic patterns of the wireless terminal would typically be determined by the location tracking server 134/136. However, an advertising server 146 may continually receive traffic patterns of wireless terminals within a mall, for example, as was illustrated in FIG. 2. With these traffic patterns determined at step 802, the advertising server generates an advertisement based upon the traffic patterns (step 804). Then, the advertising server delivers the advertisement to the wireless terminal via one or more servicing networks (step 806). The particular advertisement delivered to the wireless terminal may be relevant to a current location of the wireless terminal. For example, with reference to both FIG. 8 and FIG. 2, the advertising server may generate an advertisement corresponding to store 214 when the wireless terminal 202 is at position 202d, 202e, or 202f. Likewise, the advertising server may generate and deliver a different advertisement to wireless terminal 202 when at position 202g in an attempt to entice the user of the wireless terminal 202 to re-enter store 214.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for collecting traffic data regarding a plurality of wireless terminals comprising:
periodically receiving Global Positioning System (GPS) location information from each of the plurality of wireless terminals by a location tracking server, based upon assisted GPS operations of the wireless terminals;
for each of the plurality of wireless terminals, accumulating GPS location information reported by the wireless terminal by the location tracking server;
receiving information regarding a geographic feature;
accessing accumulated GPS location information reported by the plurality of wireless terminals relevant to the geographic feature; and
generating a traffic pattern report regarding the geographic feature based upon the accumulated GPS location information reported by the plurality of wireless terminals relevant to the geographic feature.

2. The method of claim 1, wherein periodically receiving GPS location information from each of the plurality of wireless terminals by a location tracking server comprises:
the location tracking server sending a location update query to a target wireless terminal based upon a triggering event;
the target wireless terminal determining its location in response to the location update query; and
the target wireless terminal sending a location update response to the location tracking server that includes the location.

3. The method of claim 1, wherein periodically receiving GPS location information from each of the plurality of wireless terminals by a location tracking server comprises:
a target wireless terminal determining a change in its GPS location that satisfies a positional change threshold; and
the target wireless terminal sending a GPS location update message to the location tracking server that includes the GPS location.

4. The method of claim 1, wherein periodically receiving GPS location information from each of the plurality of wireless terminals by a location tracking server comprises:
a target wireless terminal determining that a time interval since last reporting its GPS location to the location tracking server has lapsed; and
the target wireless terminal sending a location update message to the location tracking server that includes the GPS location.

5. The method of claim 1, wherein, periodically receiving GPS location information from each of the plurality of wireless terminals by a location tracking server comprises at least two of:
receiving GPS location information from a first plurality of wireless terminals via a Wireless Local Area Network (WLAN);
receiving GPS location information from a second plurality of wireless terminals via a cellular telephone network; and
receiving GPS location information from a third plurality of wireless terminals via a Metropolitan Area Network (WiMAX).

6. The method of claim 1, further comprising, for one of the plurality of wireless terminals:
determining traffic patterns of the wireless terminal;
generating an advertisement based upon the traffic patterns of the wireless terminal; and
delivering the advertisement to the wireless terminal.

7. The method of claim 1, wherein:
the geographic feature comprises a store; and
the traffic pattern report includes wireless terminal traffic volume over time for the store.

8. The method of claim 1, wherein:
the geographic feature comprises a vehicle traffic location; and
the traffic pattern report includes wireless terminal traffic volume over time for the vehicle traffic location.

9. The method of claim 1, wherein periodically receiving Global Positioning System (GPS) location information from each of the plurality of wireless terminals by a location tracking server includes receiving profile information relating to the plurality of wireless terminals.

10. A method for collecting traffic data regarding a plurality of wireless terminals comprising:
for each of the plurality of wireless terminals:
a location tracking server sending a location update query to a target wireless terminal based upon a triggering event;
the target wireless terminal determining its Global Positioning System (GPS) location information in response to the location update query, based upon assisted GPS operations; and
the target wireless terminal sending a location update response to the location tracking server that includes the GPS location information.
the location tracking server receiving the GPS location information from the target wireless terminal; and
the location tracking server accumulating the GPS location information reported by the wireless terminal; and
for each of a plurality of traffic pattern reporting requests, the location tracking server:
receiving information regarding a geographic feature;
accessing accumulated GPS location information reported by the plurality of wireless terminals relevant to the geographic feature;
processing the accumulated GPS location information to produce relevant traffic data; and
generating a traffic pattern report regarding the geographic feature based upon the accumulated GPS location information reported by the plurality of wireless terminals relevant to the geographic feature.

11. The method of claim 10, wherein receiving GPS location information from the target wireless terminal comprises receiving the GPS location information via one or more of:
a Wireless Local Area Network (WLAN);
a cellular telephone network; and
a Metropolitan Area Network (WiMAX).

12. The method of claim 10, further comprising, for one of the plurality of wireless terminals:
determining traffic patterns of the wireless terminal;
generating an advertisement based upon the traffic patterns of the wireless terminal; and
delivering the advertisement to the wireless terminal.

13. The method of claim 10, wherein:
the geographic feature comprises a store; and
the traffic pattern report includes wireless terminal traffic volume over time for the store.

14. The method of claim 10, wherein:
the geographic feature comprises a vehicle traffic location; and
the traffic pattern report includes wireless terminal traffic volume over time for the vehicle traffic location.

15. The method of claim 10, wherein the location tracking server receiving GPS location information from the target wireless terminal includes receiving profile information relating to the target wireless terminal.

16. A location tracking server for collecting traffic data regarding a plurality of wireless terminals comprising:
at least one communication interface;
memory; and
processing circuitry coupled to the at least one communication interface and to the memory and operable to:
for each of the plurality of wireless terminals:
receive GPS location information from a wireless terminal that is based upon assisted GPS operations of the wireless terminals; and
accumulating the GPS location information reported by the wireless terminal; and
for each of a plurality of traffic pattern reporting requests, the location tracking server:
receive information regarding a geographic feature;
access accumulated GPS location information reported by the plurality of wireless terminals relevant to the geographic feature;
process the accumulated GPS location information to produce relevant traffic data; and
generate a traffic pattern report regarding the geographic feature based upon the accumulated GPS location information reported by the plurality of wireless terminals relevant to the geographic feature.

17. The location tracking server of claim 16, wherein the processing circuitry is further operable to:
send a location update query to a target wireless terminal based upon a triggering event; and
receive the GPS location information from the wireless terminal in a location update response.

18. The location tracking server of claim 16, wherein the processing circuitry is further operable to, for a wireless terminal of the plurality of wireless terminals:
determine traffic patterns of the wireless terminal;
generate an advertisement based upon the traffic patterns of the wireless terminal; and
deliver the advertisement to the wireless terminal.

19. The location tracking server of claim 16, wherein:
the geographic feature comprises a store; and
the traffic pattern report includes wireless terminal traffic volume over time for the store.

20. The location tracking server of claim 16, wherein:
the geographic feature comprises a vehicle traffic location; and
the traffic pattern report includes wireless terminal traffic volume over time for the vehicle traffic location.
